(19) United States
(12) Patent Application Publication
(10) Pub. No.: US 2010/0072147 A1
(43) Pub. Date: Mar. 25, 2010

(54) CLOTH RAIL

(76) Inventors: Grethe Reenberg, Vaeggerlose (DK); Line Reenberg Vilstrup, Virum (DK)

Correspondence Address: WINSTON & STRAWN LLP;PATENT DEPARTMENT, 1700 K STREET, N.W., WASHINGTON, DC, 20006, US

(21) Appl. No.: 12/514,995

(22) PCT Filed: Oct. 24, 2007
(86) PCT No.: PCT/DK2007/050153

§ 371 Date: May 14, 2009

(30) Foreign Application Priority Data
Nov. 15, 2006 (DK) PA 2006 01494

(51) Int. Cl. A47F 7/16; F16M 13/00

(52) U.S. Cl. 211/45; 248/206.5

(57) ABSTRACT

The present invention relates to a cloth rail and in particular to a cloth rail that can be attached to a wall without use of tools. It includes a carrier part adapted to carry a cloth, such as a dishcloth. It further comprises at least one pair of magnets of which a first magnet is connected to the carrier part and a second magnet is separate and adapted to attract the first magnet. The cloth rail typically further comprises at least one connecting part forming a connection between the first magnet(s) and the carrier part.

### FIELD OF THE INVENTION

The present invention relates to cloth rails and in particular to cloth rails that can be attached to a wall without use of tools.

### BACKGROUND OF THE INVENTION

It is well-known that in many kitchens the dishcloth is often laid on the table or hung over the tap after use. This may be unhygienic, and many people find it unpleasant. A possible solution to these problems is to use a separate dish cloth holder that can be placed next to the sink. An alternative solution is known from U.S. Pat. No. 5,217,123 which discloses a rail for hanging a dishcloth on the inside surface of a kitchen sink. The rail is attached by use of two suction cups which can be attached to any smooth surface without the need to damage, such as drill holes in, the sink and without use of tools. A similar rail is known from US 2006/0026748, which rail is more flexible with respect to length and angular attachment. However, it may be difficult or impossible to attach suction cups to an uneven or dirty surface, especially if the suction cups are worn. Furthermore, even after attachment of the suction cups, they may get loose again after a while.

Hence, an improved dishcloth rail would be advantageous, and in particular a more efficient and/or reliable dishcloth rail which can still be fastened without use of tools would be advantageous.

### OBJECT OF THE INVENTION

It is an object of the present invention to provide a cloth rail which can be attached to a wall without use of tools. For some embodiments of the invention, it may be necessary to use tools to, temporarily or permanently, detach the cloth rail from the wall e.g. for cleaning.

It is a further object of the present invention to provide a cloth rail which can be attached to a wall without any need to pierce the wall.

It is a further object of the present invention to provide a cloth rail which can be attached to an uneven or dirty surface of a wall.

It is a further object of the present invention to provide a cloth rail which can easily be temporarily removed e.g. for cleaning of the cloth rail and/or the wall to which it is attached.

It is a further object of the present invention to provide an alternative to the prior art.

### SUMMARY OF THE INVENTION

Thus, the above described object and several other objects are intended to be obtained in a first aspect of the invention by providing a cloth rail comprising a carrier part adapted to carry a cloth and at least one pair of magnets of which a first magnet is connected to the carrier part and a second magnet is separate and adapted to attract the first magnet.

By “cloth” is meant any piece of cloth which it is desired to hang up e.g. for drying, for temporarily storing or for decoration. The cloth rail may also be used to carry more than one piece of clothes at a time.

By “separate” is preferably meant that the second magnet is not directly connected to or abutting other parts of the cloth rail when in use, since the second magnet is placed on an opposite surface of a wall to which the cloth rail is attached. When the cloth rail is not attached to a wall, e.g. before being taken into use, the second magnet may typically abut the first magnet due to the magnetic attractive forces.

By “wall” is preferably meant a plate-like material having two substantially parallel opposite side surfaces. There must be access to both surfaces of the wall in order to be able to place the first magnet(s) on one surface and the second magnet(s) on the opposite surface. Such a wall may e.g. be a kitchen sink or a cupboard door. It will also be possible to attach a cloth rail according to the present invention to another cloth, such as a tent wall.

The cloth rail may further comprise at least one connecting part forming a connection between the first magnet(s) and the carrier part. Each connecting part may comprise more than one piece so that the pieces together form the connection.

In preferred embodiments of the invention, the cloth rail comprises two connecting parts connected to opposite ends of the carrier part.

In some embodiments of the invention, the cloth rail comprises two pairs of magnets of which each first magnet is connected to the carrier part via a connecting part. In other embodiments the cloth rail comprises only one pair of magnets. It may also be possible to have three or more pairs of magnets.

The magnets may have a cylindrical cross section, but any shape is possible within the scope of the invention. The cross section of the two magnets of a pair of magnets may be the same, or one may be larger than the other. The thickness may also be the same or different. The magnets may also be covered on one or more surfaces with e.g. paint, enamel or plastic for decorative or protective purposes.

The carrier part may be a rod. Alternatively it may be a chain, a flexible band, a plate or any other type of design that is appropriate for carrying a cloth.

The connecting parts and carrier part may be separable in such a way that the length of the cloth rail can be changed by changing the carrier part. An adjustable length may also be obtained by use of a telescopic rod.

In some embodiments of the invention, the carrier part and the connecting part(s) are formed as one unit.

The carrier part can be made from any appropriate material including stainless steel and plastic. The choice of material will typically be a question of price, but it will also be related to other factors including aesthetic.

A second aspect of the invention relates to a use of a cloth rail as described above for hanging up a cloth after having placed the first magnet(s) on one surface of a wall and having placed the second magnet(s) on an opposite surface of the wall in such a way that the first and second magnets attract each other.

These and other aspects of the invention will be apparent from and elucidated with reference to the embodiments described hereinafter. Although the invention is described with respect to a rail for hanging up a dishcloth, it may find use in a number of other applications where it is desired to hang up a cloth. This may be to hang up e.g. a towel or clothes on a cupboard door, a washcloth on a shower door or wall, or woven pictures for decorative purposes.

### BRIEF DESCRIPTION OF THE FIGURES

The cloth rail according to the invention will now be described in more detail with regard to the accompanying figures. The figures show one way of implementing the present invention and are not to be construed as being limiting to other possible embodiments falling within the scope of the attached claim set.

FIG. 1 is a schematic top view of a cloth rail attached to a sink by use of two pairs of magnets.

FIG. 2 shows schematically an alternative embodiment where the connecting parts are formed from a bendable material.

FIGS. 3.a and 3.b show schematically two embodiments having only one pair of magnets.

FIG. 4 shows schematically an embodiment where the carrier part is attached directly to the first magnets, i.e. without the need for connecting parts.

### DETAILED DESCRIPTION OF PREFERRED EMBODIMENTS

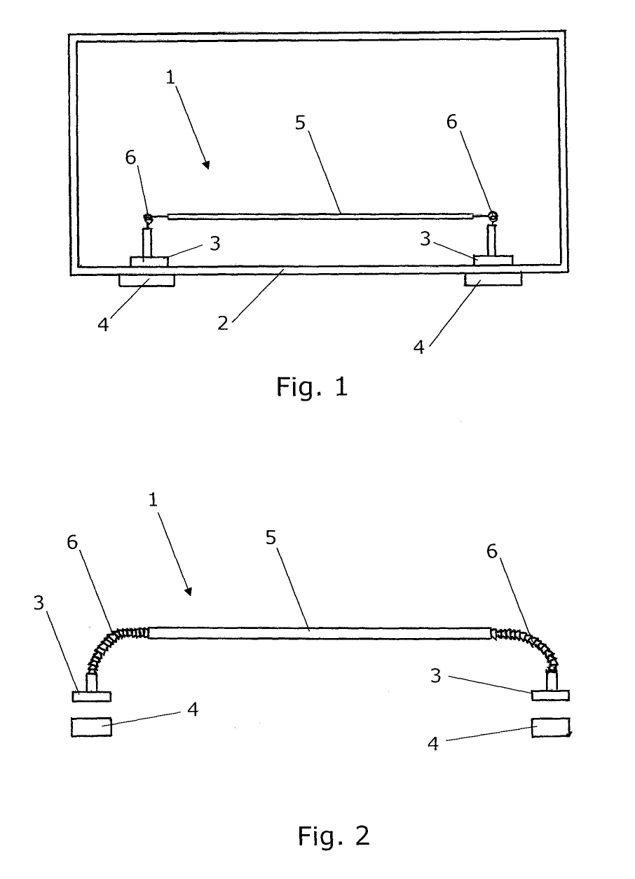

FIG. 1 is a schematic top view of a cloth rail 1 attached to a wall 2 of a kitchen sink by use of two pairs of magnets 3,4. The sink is illustrated as having a rectangular shape, but any shape that allows for attachment of the magnets is possible within the scope of the invention. Each pair of magnets 3,4 comprises a first magnet 3 connected to the carrier part 5 of the cloth rail 1 and a second magnet 4 placed on an opposite side of the wall 2. The attractive forces of the magnets must be large enough to ensure that the cloth rail is securely fastened and still weak enough to allow for removal of the cloth rail. The strength of the magnets may therefore depend on the type of wall to which the cloth rail is to be attached.

In the embodiment shown, the carrier part 5 and the first magnets 3 are interconnected by ring-shaped connecting parts 6, such as screw eyes. The same effect can be obtained e.g. by hook-and-loop connections, but any type of connection providing a corresponding freedom of movement is possible within the scope of the invention. In FIG. 1 the two pairs of magnets 3,4 are illustrated as attached to the same wall 2. It will however also be possible to attach the pair of magnets 3,4 to two different walls 2.

It is also possible within the scope of the invention to use two long magnets 3,4 instead of four smaller magnets.

FIG. 2 shows schematically an alternative embodiment wherein the connecting parts 6 are made from a bendable material, such as metal, silicone or plastic. The connecting parts are illustrated as being made from joints which are mutually moveable. However, each connecting part 6 may also be made from one flexible piece of material having a smooth surface. The connecting parts 6 may be connected with the carrier part 5 and the magnets 3,4 e.g. by gluing, welding, vulcanisation or screw connections.

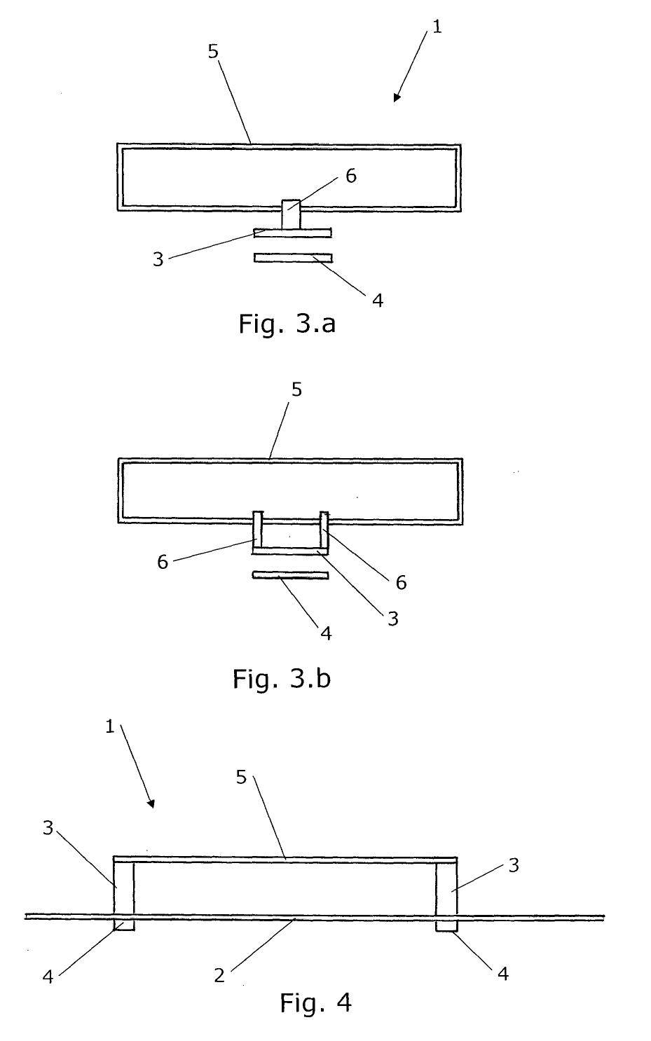

FIG. 3 shows schematically two embodiments having only one pair of magnets 3,4 which is preferably placed midway along the length of the carrier part 5. Two connecting parts 6, as shown in FIG. 3.b, may be used instead of one, as shown in FIG. 3.a, for stability, weight, or aesthetic reasons.

FIG. 4 shows schematically an embodiment where the carrier part 5 is attached directly to the first magnets 3, i.e. without the need for connecting parts 6. In this case the first magnets 3 must have a size which ensures that a cloth (not shown) can easily be placed between the carrier part 5 and the wall 2 to which the cloth rail 1 is attached. If the carrier part 5 is made from a magnetic material, it can be attached to the first magnets 3 by magnetic forces only. The correct positioning may furthermore be ensured by having grooves (not shown) in the magnets 3 with a shape corresponding to the cross section of the carrier part 5.

In some embodiments of the invention, the carrier part 5 can easily be removed from the cloth rail 1 whereby the surface of a wall, such as a kitchen sink, to which the cloth rail 1 is attached can be cleaned without removal of the magnets. This will e.g. be the case with the embodiment shown in FIG. 4, but other designs which allow for such option will be obvious for a person skilled in the art.

A cloth rail 1 according to the invention may be one assembled unit, except for the second magnets 4. Alternatively the carrier part 5 and the connecting parts 6 may be one unit adapted to be fastened to the first magnets 3. It is also possible within the scope of the invention that the carrier part 5 is exchangeable, e.g. if another length is desired, or if it is broken or miscoloured. This may be possible by use of hook-and-loop connections or any other easily separable connections which will be well-known to a person skilled in the art.

The cloth carrier 1 can be attached to the wall 2 by holding the first magnets 3 close to one surface of the wall 2 and placing the second magnets 4 on the opposite surface of the wall 2. If the wall 2 is made from a material attracted by magnets, the first magnets 3 with the carrier part 5 may be attached to the wall 2 even without the second magnets 4, which are thereafter attached to the opposite surface of the wall 2 to ensure that the cloth carrier 1 stays in place also when a cloth is hung thereon.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1-10. (canceled)

11. A cloth rail comprising:
a carrier part adapted to carry a cloth,
at least one pair of magnets comprising a first magnet and a second magnet, and
at least one connecting part forming a connection between the first magnet(s) and the carrier part;
where the first magnet(s) is connected to the carrier part and the second magnet(s) is separate and adapted to attract the first magnet(s), and
wherein the at least one connecting part is made from a bendable material.

12. The cloth rail of claim 11, wherein the at least one connecting part is made from joints that are mutually moveable or made from one flexible piece of material having a smooth surface.

13. The cloth rail of claim 11, wherein the at least one connecting part is made from metal, silicone or plastic.

14. The cloth rail of claim 11, further comprising two pairs of magnets of which each first magnet is connected to the carrier part via a connecting part.

15. The cloth rail of claim 11, comprising only one pair of magnets.

16. The cloth rail of claim 11, wherein the carrier part is a rod.

17. The cloth rail of claim 16, wherein the rod is a telescopic rod.

18. The cloth rail of claim 11, wherein the carrier part and the connecting part(s) are formed as one unit.

19. The cloth rail of claim 11, wherein the magnets has a protective covering on one or more surfaces, preferably of paint, enamel or plastic.

20. The cloth rail of claim 11, wherein at least the carrier part is made from plastic or from stainless steel.

21. A method of drying a cloth, which comprises:
installing the cloth rail of claim 11 by:
placing the first magnet(s) on one surface of a wall; and
placing the second magnet(s) on an opposite surface of the wall in such a way that the first and second magnets attract each other; and
hanging a cloth on the rail after installation.
